(19) United States
(12) Patent Application Publication
(10) Pub. No.: US 2016/0104915 A1
(43) Pub. Date: Apr. 14, 2016

(54) HYBRID ION BATTERY SYSTEM

(71) Applicant: Toyota Jidosha Kabushiki Kaisha, Toyota-shi Aichi-ken (JP)

(72) Inventor: Shinji Nakanishi, Mishima-shi Shizuoka-ken (JP)

(21) Appl. No.: 14/872,595

(22) Filed: Oct. 1, 2015

(30) Foreign Application Priority Data
Oct. 8, 2014 (JP) 2014-207062

(51) Int. Cl. H01M 10/0561; H01M 10/054; H01M 10/615; H01M 4/583; H01M 4/58; H01M 10/0525; H01M 4/485

(52) U.S. Cl. CPC H01M 10/0561; H01M 10/0525; H01M 10/054; H01M 4/485; H01M 4/583; H01M 4/5825; H01M 10/615; H01M 2300/0048

(57) ABSTRACT

A hybrid ion battery system is disclosed which includes a hybrid ion battery of a Li ion and a Na ion, and a heating unit, wherein the hybrid ion battery includes a cathode active material layer containing a cathode active material, an anode active material layer containing an anode active material, and an electrolyte layer formed between the cathode active material layer and the anode active material layer, the cathode active material is an active material containing at least Na, the anode active material is an active material capable of absorbing and releasing the Li ion, the electrolyte layer contains a molten salt composed of LiN(SO₂F)₂ and NaN(SO₂F)₂ and contains no solvent, and the heating unit heats the hybrid ion battery to a temperature such that the molten salt becomes in a molten state.

### TECHNICAL FIELD

The present specification relates to a hybrid ion battery system comprising a hybrid ion battery having high capacity and favorable rate characteristics.

### BACKGROUND ART

In accordance with a rapid spread of information relevant apparatuses and communication apparatuses such as a personal computer, a video camera and a portable telephone in recent years, the development of a battery as a power source thereof has been emphasized. The development of a lithium ion battery and a sodium ion battery as a battery used for an electric automobile or a hybrid automobile has been advanced, for example, in the automobile industry in the field except information relevant apparatuses and communication relevant apparatuses. Na exists so abundantly as compared with Li that a sodium ion battery has the advantage that lower costs are easily achieved as compared with a lithium ion battery.

Also, a hybrid ion battery in which two ions (such as Li ions and Na ions) move in the battery has been researched. Such a hybrid ion battery ordinarily has a cathode active material layer containing a cathode active material, an anode active material layer containing an anode active material, and an electrolyte layer formed between the cathode active material layer and the anode active material layer.

Conventionally, an anode active material in a hybrid ion battery is so low in capability of absorbing and releasing Na ions that the problem is that input and output characteristics as the whole battery are low and metal Na precipitates after a long-term cycle. A hybrid ion battery using an anode active material capable of absorbing and releasing Li ions is proposed for the problem (Cited Literature 1). Specifically, in Patent Literature 1, a hybrid ion battery is disclosed in which a cathode active material contains an Na₄M₃ (PO₄)₂P₂O₇ crystal phase (M is at least one kind of Ni, Co, Mn, Fe, V, Cr, Cu and Zn), an anode active material is an active material capable of absorbing and releasing Li ions, and an electrolyte layer contains at least Li ions.

### CITATION LIST

### Patent Literatures

Patent Literature 1: Japanese Patent Application (JP-A) No. 2014-096261
Patent Literature 2: JP-A No. 2013-232327

### SUMMARY OF INVENTION

### Technical Problem

In a hybrid ion battery, Na ions are released from a cathode active material layer to an electrolyte layer during charge, and Li ions contained in the electrolyte layer are absorbed to an anode active material layer by the amount corresponding to the amount of the released Na ions. Then, the capacity of the hybrid ion battery is determined by the amount of the Li ions to be absorbed to the anode active material layer.

Ordinarily, the amount of Na ions contained in a cathode active material layer is by far larger as compared with the amount of Li ions contained in an electrolyte layer. Thus, the capacity of a hybrid ion battery is influenced by the amount of Li ions contained in an electrolyte layer. For example, in Cited Literature 1, an Li salt and a solvent are used as a material for an electrolyte layer containing Li ions; in this case, it is difficult to intend a further improvement in the capacity of a hybrid ion battery for the reason that the concentration of the Li salt soluble in the solvent is limited. Also, in the case where the Li salt contained in an electrolyte layer is small in amount, the problem is that the reaction falls into rate controlling and favorable rate characteristics are not obtained.

The main object of the present specification is to provide a hybrid ion battery system comprising a hybrid ion battery having high capacity and favorable rate characteristics.

### Solution to Problem

As a salt composed of a specific Li salt and a specific Na salt becomes in a molten state at comparatively low temperature, the amount of Li ions contained in an electrolyte layer may be increased as compared with a conventional amount thereof when a battery is produced by using the molten salt without using a solvent for an electrolyte layer.

That is to say, the present specification provides a hybrid ion battery system comprising a hybrid ion battery of a Li ion and a Na ion, and a heating unit, wherein the hybrid ion battery comprises a cathode active material layer containing a cathode active material, an anode active material layer containing an anode active material, and an electrolyte layer formed between the cathode active material layer and the anode active material layer, the cathode active material is an active material containing at least Na, the anode active material is an active material capable of absorbing and releasing the Li ion, the electrolyte layer contains a molten salt composed of LiN(SO₂F)₂ and NaN(SO₂F)₂ and contains no solvent, and the heating unit heats the hybrid ion battery to a temperature such that the molten salt becomes in a molten state.

According to the present specification, the electrolyte layer contains a molten salt composed of LiN(SO₂F)₂ and NaN(SO₂F)₂ and contains no solvent, so as to allow a hybrid ion battery system having high capacity and favorable rate characteristics.

In the present specification, the anode active material is preferably hard carbon or Li₄Ti₅O₁₂.

In the present specification, the cathode active material preferably contains an Na₄M₃(PO₄)₂P₂O₇ crystal phase (M is at least one kind of Co, Ni, and Mn).

### Advantageous Effects of Invention

The present specification produces the effect such as to provide a hybrid ion battery system comprising a hybrid ion battery having high capacity and favorable rate characteristics.

### BRIEF DESCRIPTION OF DRAWINGS

FIG. 1 is a schematic cross-sectional view showing an example of a hybrid ion battery in the present specification.

FIG. 2 is a schematic cross-sectional view showing an example of a hybrid ion battery system of the present specification.

FIG. 3A is a schematic cross-sectional view showing another example of a hybrid ion battery system of the present specification.

FIG. 3B is a schematic cross-sectional view showing still another example of a hybrid ion battery system of the present specification.

### DESCRIPTION OF EMBODIMENTS

A hybrid ion battery system of the present specification is hereinafter described in detail.

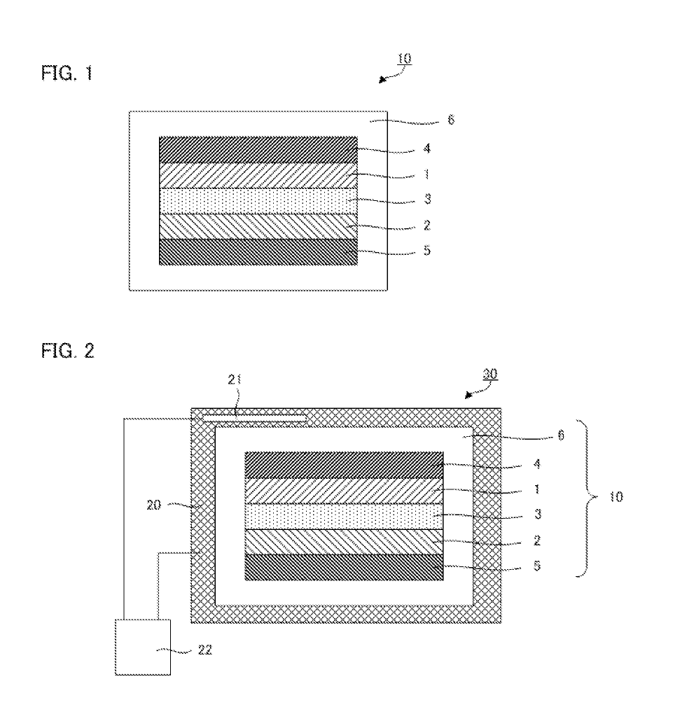

FIG. 1 is a schematic cross-sectional view showing an example of the hybrid ion battery in the present specification. A hybrid ion battery 10 shown in FIG. 1 comprises a cathode active material layer 1, an anode active material layer 2, an electrolyte layer 3 formed between the cathode active material layer 1 and the anode active material layer 2, a cathode current collector 4 for collecting the cathode active material layer 1, an anode current collector 5 for collecting the anode active material layer 2, and a battery case 6 for storing these members. The hybrid ion battery in the present specification has a characteristic that the electrolyte layer 3 contains a molten salt composed of LiN(SO₂F)₂ and NaN(SO₂F)₂ and contains no solvent.

FIG. 2 is a schematic cross-sectional view showing an example of the hybrid ion battery system of the present specification. As shown in FIG. 2, a hybrid ion battery system 30 of the present specification comprises the hybrid ion battery 10 and a heating unit 20. The heating unit 20 heats to a temperature such that the molten salt contained in the electrolyte layer 3 of the hybrid ion battery 10 becomes in a molten state. The heating unit 20 may include a temperature detection unit 21 for detecting the temperature of a hybrid ion battery 10, and an electronic control unit 22 that controls the temperature of the heating unit 20.

According to the present specification, the electrolyte layer contains a molten salt composed of LiN(SO₂F)₂ and NaN(SO₂F)₂ and contains no solvent, so as to allow a hybrid ion battery system having high capacity and favorable rate characteristics. The reason therefor is conceived to be as follows. That is to say, the mixing of solid LiN(SO₂F)₂ at normal temperature (25° C.) and solid NaN(SO₂F)₂ at normal temperature (25° C.) allows the melting point to be lowered as compared with LiN(SO₂F)₂ singly. Thus, the molten salt composed of LiN(SO₂F)₂ and NaN(SO₂F)₂ may be used as an electrolyte material under the temperature conditions of the melting point or more to allow a solvent to be unnecessary. Accordingly, it is conceived that the amount of an Li salt contained in the electrolyte layer, namely, the amount of Li ions may be increased without being influenced by the upper limit of an Li salt concentration soluble in a solvent as a conventional hybrid ion battery to allow the capacity of a hybrid ion battery to be improved. Also, in the case where a large amount of an Li salt exists in the electrolyte layer, it is conceived that favorable rate characteristics are obtained for the reason that the restraint of fluctuation of the salt concentration allows the stabilization of ion conductance to be intended.

The hybrid ion battery system of the present specification is hereinafter described in each constitution.

1. Hybrid Ion Battery

A hybrid ion battery in the present specification comprises a cathode active material layer, an anode active material layer and an electrolyte layer.

The hybrid ion battery in the present specification is hereinafter described in each constitution.

(1) Electrolyte Layer

The electrolyte layer in the present specification is a layer formed between the cathode active material layer and the anode active material layer, and contains a molten salt composed of at least LiN(SO₂F)₂ and NaN(SO₂F)₂ and contains no solvent.

In the present specification, “molten salt” is synonymous with ionic liquid. Also, “molten salt” herein signifies such that the melting point is 120° C. or less. Above all, the melting point of a molten salt of the present specification is preferably 100° C. or less, more preferably 90° C. or less, particularly preferably 80° C. or less.

Also, in the present specification, “contains no solvent” signifies that the ratio of a solvent with respect to the total weight of all electrolyte materials contained in the electrolyte layer is ordinarily 10 wt % or less, above all, preferably 5 wt % or less, particularly, preferably 1 wt % or less.

The molten salt in the present specification contains LiN(SO₂F)₂ and NaN(SO₂F)₂. LiN(SO₂F)₂ has a melting point of 127° C. and is solid at normal temperature (25° C.) Also, NaN(SO₂F)₂ has a melting point of 103° C. and is solid at normal temperature (25° C.) In the present specification, the mixing of solid NaN(SO₂F)₂ at normal temperature (25° C.) into solid LiN(SO₂F)₂ at normal temperature (25° C.) allows the melting point to be lowered. Accordingly, the molten salt composed of LiN(SO₂F)₂ and NaN(SO₂F)₂ may be used as an electrolyte material under the comparatively low temperature conditions.

The molten salt in the present specification may be composed of only LiN(SO₂F)₂ and NaN(SO₂F)₂, or plural salts containing a salt except LiN(SO₂F)₂ and NaN(SO₂F)₂ as required. For example, the molten salt in the present specification may be composed of only LiN(SO₂F)₂, NaN(SO₂F)₂ and KN(SO₂F)₂, or plural salts containing a salt except LiN(SO₂F)₂, NaN(SO₂F)₂ and KN(SO₂F)₂ as required. KN(SO₂F)₂ has a melting point of 103° C. and is solid at normal temperature (25° C.)

In the case where the molten salt in the present specification is composed of LiN(SO₂F)₂ and NaN(SO₂F)₂, the ratio of LiN(SO₂F)₂ is not particularly limited if the desired molten salt is obtained. In the present specification, the ratio of LiN(SO₂F)₂ is preferably high from the viewpoint of improving the capacity of a hybrid ion battery. For example, as the after-mentioned Example 1, in the case where the cathode active material layer contains an Na source and the anode active material layer contains hard carbon, an Li source is not contained in the cathode active material layer and the anode active material layer, so that the ratio of LiN(SO₂F)₂ is preferably high from the viewpoint of improving the capacity of a hybrid ion battery. Specifically, in the case where the total of LiN(SO₂F)₂ and NaN(SO₂F)₂ is regarded as 100 parts by mol, LiN(SO₂F)₂ is contained preferably at a ratio of 5 parts by mol or more, above all, preferably at a ratio of 10 parts by mol or more, particularly, preferably at a ratio of 20 parts by mol or more. Also, in the case where the total of LiN(SO₂F)₂ and NaN(SO₂F)₂ is regarded as 100 parts by mol, LiN(SO₂F)₂ is contained preferably at a ratio of 95 parts by mol or less, above all, preferably at a ratio of 90 parts by mol or less, particularly, preferably at a ratio of 80 parts by mol or less. In particular, the ratio of LiN(SO₂F)₂ within a range of 5 parts by mol to 95 parts by mol allows the melting point of the molten salt to be sufficiently lowered as compared with the melting point of LiN(SO₂F)₂ and NaN(SO₂F)₂ singly. Specifically, the melting point of the molten salt may be determined at a temperature range of 70° C. to 75° C. Thus, the specification to an actual hybrid ion battery may be offered.

Also, in the case where the molten salt in the present specification is composed of LiN(SO₂F)₂, NaN(SO₂F)₂ and KN(SO₂F)₂, the ratio of LiN(SO₂F)₂ is not particularly limited if the desired molten salt is obtained. In the present specification, the ratio of LiN(SO₂F)₂ is preferably high from the viewpoint of improving the capacity of a hybrid ion battery. For example, in the case where the total of LiN(SO₂F)₂, NaN(SO₂F)₂ and KN(SO₂F)₂ is regarded as 100 parts by mol, LiN(SO₂F)₂ is contained preferably at a ratio of 5 parts by mol or more, above all, preferably at a ratio of 10 parts by mol or more, particularly, preferably at a ratio of 20 parts by mol or more. Also, in the case where the total of LiN(SO₂F)₂, NaN(SO₂F)₂ and KN(SO₂F)₂ is regarded as 100 parts by mol, LiN(SO₂F)₂ is contained preferably at a ratio of 95 parts by mol or less, above all, preferably at a ratio of 90 parts by mol or less, particularly, preferably at a ratio of 80 parts by mol or less. The effect by the ratio of LiN(SO₂F)₂ within the range is the same as the effect obtained in the case where the molten salt is composed of LiN(SO₂F)₂ and NaN(SO₂F)₂; therefore, the description herein is omitted.

In addition, in the case where the molten salt in the present specification is composed of LiN(SO₂F)₂, NaN(SO₂F)₂ and KN(SO₂F)₂, the ratio of KN(SO₂F)₂ is not particularly limited if the desired molten salt is obtained. In the present specification, a higher ratio of KN(SO₂F)₂ allows the melting point of the molten salt to be further lowered. For example, in the case where the total of LiN(SO₂F)₂, NaN(SO₂F)₂ and KN(SO₂F)₂ is regarded as 100 parts by mol, KN(SO₂F)₂ is contained preferably at a ratio of 2 parts by mol or more, above all, preferably at a ratio of 3 parts by mol or more, particularly, preferably at a ratio of 5 parts by mol or more. Also, in the case where the total of LiN(SO₂F)₂, NaN(SO₂F)₂ and KN(SO₂F)₂ is regarded as 100 parts by mol, KN(SO₂F)₂ is contained preferably at a ratio of 50 parts by mol or less, above all, preferably at a ratio of 30 parts by mol or less, particularly, preferably at a ratio of 20 parts by mol or less. The ratio of KN(SO₂F)₂ within the range allows the melting point of the molten salt to be further lowered, and allows the capacity of a hybrid ion battery to be efficiently improved.

The thickness of the electrolyte layer varies greatly with constitutions of an intended hybrid ion battery, and is preferably, for example, within a range of 0.1 μm to 1000 μm, above all, within a range of 0.1 μm to 300 μm.

(2) Cathode Active Material Layer

The cathode active material layer in the present specification is a layer containing at least a cathode active material.

The cathode active material is not particularly limited if the cathode active material may be used for a hybrid ion battery of Li ions and Na ions, and is an active material containing at least Na. In other words, the cathode active material is not particularly limited if the cathode active material is an active material containing Na while Li ions and Na ions are coinserted thereinto and codesorbed therefrom in accordance with charge and discharge of a hybrid ion battery.

The active material containing Na is preferably, for example, a metal oxide. The metal oxide is preferably, for example, an Na₄M₃(PO₄)₂P₂O₇ crystal phase (M is at least one kind of Co, Ni, and Mn). The Na₄M₃(PO₄)₂P₂O₇ crystal phase exhibits so comparatively high electric potential on the basis of sodium electrode potential as to allow cathode potential of the cathode active material to be raised to a desired value (such as 4.2 V or more). Thus, Li ions and Na ions may be favorably coinserted thereinto and codesorbed therefrom in accordance with charge and discharge of a hybrid ion battery.

The presence of “Na₄M₃(PO₄)₂P₂O₇ crystal phase” in the present specification may be confirmed by X-ray diffraction (XRD) measurement, for example. For example, the presence of the Na₄M₃(PO₄)₂P₂O₇ crystal phase may be confirmed by ordinarily having a characteristic peak in 2θ=9.8°, 16.0°, 17.0°, 23.9°, 29.5°, 32.2°, 34.0°, and 37.0°. Incidentally, this peak position may fluctuate within a range of ±1°.

The cathode active material is preferably large in the ratio of the Na₄M₃(PO₄)₂P₂O₇ crystal phase; specifically, the cathode active material preferably contains the Na₄M₃(PO₄)₂P₂O₇ crystal phase mainly. Here, “containing the Na₄M₃(PO₄)₂P₂O₇ crystal phase mainly” indicates that the ratio of the Na₄M₃(PO₄)₂P₂O₇ crystal phase is the largest in all crystal phases contained in the cathode active material. The specific ratio of the Na₄M₃(PO₄)₂P₂O₇ crystal phase contained in the cathode active material is preferably 50 mol % or more, more preferably 60 mol % or more, and far more preferably 70 mol % or more. Also, the cathode active material may be composed only of the Na₄M₃(PO₄)₂P₂O₇ crystal phase (a single-phase active material). Incidentally, the ratio of the Na₄M₃(PO₄)₂P₂O₇ crystal phase contained in the cathode active material may be determined by a quantitative analysis method through X-ray diffraction (such as a quantification method by R-value and a Rietveld method).

M contained in the Na₄M₃(PO₄)₂P₂O₇ crystal phase is not particularly limited as long as M is at least one kind of Co, Ni and Mn Also, the M is not particularly limited as long as the M has at least one kind of the elements described above, but may be only one kind of the elements described above or a combination of the elements described above and other elements. In the present specification, the M is preferably Co.

Also, the Na₄M₃(PO₄)₂P₂O₇ crystal phase preferably has a crystal structure assigned to a space group Pn2₁a. The reason therefor is conceived to be that in the case of having a crystal structure assigned to the above-described space group, all Na ions in the crystal structure are arrayed in any direction of an “a” axis, “b” axis and “c” axis so as to be very advantageous to the conduction of the Na ions.

In the present specification, other examples of the active material containing Na to be used include a prussian blue analog, a metal oxide represented by NaMO₂ (M is at least one kind of Fe, Co, Ni, and Mn), and polyaniline represented by Na₂MP₂O₇ (M is at least one kind of Fe, Co, Ni, and Mn), Na₂MPO₄F (M is at least one kind of Fe, Co, Ni, and Mn) and Na₂MSO₄ (M is at least one kind of Fe, Co, Ni, and Mn).

In addition, the cathode active material in the present specification preferably has a cathode potential of 4.2 V or more on the basis of sodium electrode potential. The reason therefor is that Li ions and Na ions may be favorably coinserted thereinto and codesorbed therefrom in accordance with charge and discharge of a hybrid ion battery.

The shape of the cathode active material of the present specification is preferably a particulate shape, for example. Also, the average particle diameter thereof (D₅₀) is preferably, for example within a range of 1 nm to 100 μm, above all within a range of 10 nm to 30 μm.

The cathode active material layer in the present specification may contain at least one of a conductive material and a binder as required in addition to the cathode active material described above. Examples of the conductive material include a carbon material. In addition, specific examples of the carbon material include acetylene black, Ketjen Black, carbon black, coke, carbon fiber and graphite. Also, the binder is not particularly limited as long as the binder is stable chemically and electrically, but examples thereof include fluorine-containing binders such as polyvinylidene fluoride (PVdF) and polytetrafluoroethylene (PTFE), and rubber-based binders such as styrene-butadiene rubber (SBR).

The content of the cathode active material in the cathode active material layer is preferably larger from the viewpoint of capacity; preferably, for example within a range of 60% by weight to 99% by weight, above all within a range of 70% by weight to 95% by weight. Also, the content of the conductive material is preferably smaller as long as the material may secure desired electron conduction; preferably, for example within a range of 1% by weight to 30% by weight.

The thickness of the cathode active material layer varies greatly with the constitution of an intended hybrid ion battery, and is preferably within a range of 0.1 μm to 1000 μm, for example.

(3) Anode Active Material Layer

The anode active material layer in the present specification is a layer containing at least the anode active material. Also, the anode active material is characterized by being an active material capable of absorbing and releasing Li ions. The anode active material used for the present specification is not particularly limited as long as the anode active material is an active material capable of absorbing and releasing Li ions, and examples thereof include a metal Li, a Li alloy, metal oxide, metal sulfide, metal nitride, and a carbon material such as a hard carbon and graphite. In the present specification, the hard carbon, the metal oxide and the metal Li are preferable among them. Here, an aspect (a first aspect) in which the anode active material is a hard carbon, an aspect (a second aspect) in which the anode active material is Li₄Ti₅O₁₂ as an example of metal oxide, and an aspect (a third aspect) in which the anode active material is a metal Li are each described.

First, the first aspect is described. The first aspect is an aspect such that hard carbon is used as the anode active material. According to the aspect, the use of the cathode active material described above and hard carbon as the anode active material by combination allows a hybrid ion battery with high durability. Hard carbon may restrain expansion and contraction of a crystal structure in accordance with absorption and release of Li ions. Thus, even though absorption and release of Li ions are repeated, a crystal structure is so stable as to allow volumetric change to be decreased and allow a hybrid ion battery with excellent durability to be offered.

Next, the second aspect is described. The second aspect is an aspect such that Li₄Ti₅O₁₂ as metal oxide is used as the anode active material. According to the aspect, the use of the cathode active material described above and Li₄Ti₅O₁₂ as the anode active material by combination allows a hybrid ion battery with high safety. The reason for improving the safety of a hybrid ion battery is conceived to be that the use of Li₄Ti₅O₁₂ as the anode active material causes Na ions eluted from the cathode active material described above during charge to be precipitated with difficulty on the anode active material.

Further, the third aspect is described. The third aspect is an aspect such that metal Li is used as the anode active material. According to the aspect, the use of the cathode active material described above and metal Li as the anode active material by combination allows a high-voltage hybrid ion battery. Examples of the anode active material used for a general hybrid ion battery include metal Na. The oxidation-reduction potential of Li is so lower than the oxidation-reduction potential of Na on the basis of Li that the use in combination with the cathode active material described above allows a hybrid ion battery exhibiting larger potential difference, that is, a higher-voltage hybrid ion battery.

The anode active material layer in the present specification may further contain at least one of a conductive material and a binder as required in addition to the anode active material. Incidentally, the conductive material and the binder used for the anode active material layer are the same as the cathode active material layer. Also, the content of the anode active material, the conductive material and the binder in the anode active material layer is the same as the cathode active material layer.

The thickness of the anode active material layer varies greatly with the constitution of an intended hybrid ion battery, and is preferably within a range of 0.1 μm to 1000 μm, for example.

(4) Other Constitutions

The hybrid ion battery of the present specification comprises at least the anode active material layer, cathode active material layer and electrolyte layer described above, ordinarily further comprising a cathode current collector for collecting the cathode active material layer and an anode current collector for collecting the anode active material layer. Examples of a material for the cathode current collector include SUS, aluminum, nickel, iron, titanium and carbon. On the other hand, examples of a material for the anode current collector include SUS, copper, nickel and carbon. Also, examples of the shape of the cathode current collector and the anode current collector include a foil shape, a mesh shape and a porous shape.

The hybrid ion battery of the present specification may have a separator between the cathode active material layer and the anode active material layer. The reason therefor is to allow the battery with higher safety. Examples of a material for the separator include porous membranes such as polyethylene (PE), polypropylene (PP), cellulose and polyvinylidene fluoride; and nonwoven fabrics such as resin nonwoven fabric and glass fiber nonwoven fabric. Also, the separator may be a single-layer structure (such as PE and PP) or a laminated structure (such as PP/PE/PP). Also, a battery case of a general battery may be used for a battery case used for the present specification. Examples of the battery case include a battery case made of SUS.

(5) Hybrid Ion Battery

The hybrid ion battery of the present specification is not particularly limited as long as the battery comprises the cathode active material layer, anode active material layer and electrolyte layer described above. Also, the hybrid ion battery of the present specification may be a primary battery or a secondary battery, preferably a secondary battery among them. The reason therefor is to be repeatedly charged and discharged and be useful as a car-mounted battery, for example. Also, examples of the shape of the hybrid ion battery of the present specification include a coin shape, a laminate shape, a cylindrical shape and a rectangular shape. Also, a producing method of the hybrid ion battery is not particularly limited as long as the method is a method which may produce the hybrid ion battery described above.

The operating temperature of a hybrid ion battery in the present specification is properly adjusted in accordance with the melting point of a molten salt contained in the electrolyte layer, and may be a temperature of the melting point or more of a molten salt. For example, the operating temperature of a hybrid ion battery is preferably 120° C. or less, above all, preferably 100° C. or less, more preferably 90° C. or less, particularly preferably 80° C. or less. Incidentally, a hybrid ion battery is heated to a predetermined temperature by the after-mentioned heating unit.

2. Heating Unit

A heating unit in the present specification controls the hybrid ion battery described above to a temperature such that a molten salt becomes in a molten state. In the present specification, “temperature such that a molten salt becomes in a molten state” signifies a temperature of the melting point or more of a molten salt. Accordingly, the temperature to which the heating unit heats is properly adjusted in accordance with the melting point of a molten salt to be used. The temperature to which the heating unit heats is, for example, preferably 65° C. or more, above all, preferably 75° C. or more. Also, the temperature to which the heating unit heats is not particularly limited but is, for example, preferably 130° C. or less, above all, preferably 100° C. or less, more preferably 90° C. or less, particularly preferably 80° C. or less.

The heating unit in the present specification is not particularly limited if the heating unit may heat the hybrid ion battery to a predetermined temperature. The heating unit may be placed in the outside of a battery case of the hybrid ion battery, or in the inside thereof. As compared with the case of placing the heating unit in the inside thereof, the case where the heating unit is placed in the outside of a battery case has the advantage that the heating unit may be prevented from deteriorating due to an electrode reaction to allow a hybrid ion battery system with excellent durability. On the other hand, the case where the heating unit is placed in the inside of a battery case has the advantage that the hybrid ion battery may be efficiently heated.

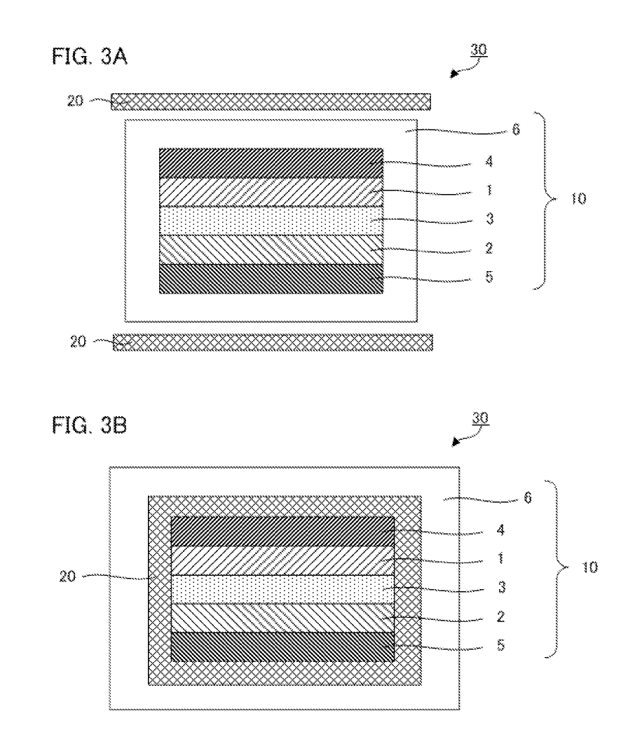

Also, in the case where the heating unit is placed in the outside of a battery case, a heating unit 20 may be placed so as to contact with the external surface of a battery case 6 as shown in FIG. 2, or so as to have a predetermined interval to the external surface of a battery case 6 as shown in FIG. 3A. The former has the advantage that the battery case may be efficiently warmed up, whereas the latter has the advantage that a location for placing the heating unit is restricted so less as to facilitate the design. In addition, in the case where the heating unit is placed so as to contact with the external surface of the battery case, the heating unit may cover the whole surface of the battery case, or part of the battery case. On the other hand, in the case where the heating unit is placed so as to have a predetermined interval to the external surface of the battery case, the heating unit may be placed so as to surround the whole surface of the battery case, or so as to heat part of the battery case.

Also, in the case where the heating unit is placed in the inside of a battery case, a location for placing the heating unit is not particularly limited, but examples thereof include the case where the heating unit 20 is formed in the internal surface of the battery case 6, for example, as shown in FIG. 3B. In addition, in this case, a protective layer (not shown in FIG.) for preventing the heating unit 20 from deteriorating may be formed on the surface on which the heating unit 20 contacts with a cathode active material layer 1, an anode active material layer 2 and an electrolyte layer 3.

Examples of the heating unit in the present specification include a unit which generates heat by electric resistance. Specifically, examples thereof include a metal heating element such as iron-chromium-aluminum heating element and nickel-chromium heating element. Also, other examples of the heating unit include a cylindrical member inside which warmed gas or liquid flows. In particular, in the case where a hybrid ion battery system of the present specification is used for mounting on a car, examples of a member for heating the hybrid ion battery include a heating unit such as an internal combustion engine and a cylindrical member inside which exhaust gas flows.

On the other hand, other examples of the heating unit in the present specification include a member for heating by irradiating microwaves.

3. Hybrid Ion Battery System

A hybrid ion battery system of the present specification is not particularly limited as long as the hybrid ion battery system has the hybrid ion battery and heating unit described above.

Incidentally, the present specification is not limited to the embodiments. The embodiments are exemplification, and any one is included in the technical scope of the present specification as long as it has substantially the same constitution as the technical idea described in the claim of the present specification and offers similar operation and effect thereto.

### EXAMPLES

The present specification is described more specifically by showing examples hereinafter.

### Example 1

(Production of active material) Na₄P₂O₇ as a Na source, (CH₃COO)₂Co as a Co source, and NH₄H₂PO₄ and Na₄P₂O₇ as a P source were prepared and mixed to obtain a raw material mixture. Incidentally, they were mixed so that the ratio of Na, Co and P in the raw material mixture was Na:Co:P=4:3:4 (molar ratio). The obtained raw material mixture was dissolved with glycolic acid (gelling agent) in a nitric acid aqueous solution, and stirred at a temperature of 80° C. The obtained mixture (gel) was burned under an air atmosphere at a temperature of 700° C. for 50 hours. Thus, a cathode active material having an Na₄CO₃(PO₄)₂P₂O₇ crystal phase (space group Pn2₁a) was obtained.

(Production of Evaluation Battery)

The obtained cathode active material, a conductive material (carbon material), and a binder (PVdF) were mixed at cathode active material:conductive material:binder=85:10:5 (weight ratio (wt %)), and dispersed into N-methyl 2-pyrrolidone (NMP) as a dispersant to prepare slurry. Next, the obtained slurry was applied on an aluminum foil as a current collector, dried and rolled to produce a cathode.

Subsequently, an anode active material (hard carbon) and a binder (PVdF) were mixed at anode active material:binder=97:3 (weight ratio (wt %)), and applied onto an aluminum foil to produce an anode.

Thereafter, a CR2032-type coin cell was used, the cathode was used as a working electrode, the anode was used as a counter electrode, and a microporous membrane separator of polypropylene/polyethylene/polypropylene was used as a separator. A molten salt in which NaN(SO₂F)₂ and LiN(SO₂F)₂ were mixed at NaN(SO₂F)₂:LiN(SO₂F)₂=20:80 (molar ratio) was used for an electrolyte layer. Thus, an evaluation battery was obtained. Incidentally, when NaN(SO₂F)₂ having a melting point of 103° C. and LiN(SO₂F)₂ having a melting point of 127° C. were mixed, the molten salt having a melting point of 71° C. was obtained.

### Example 2

An anode active material (Li₄Ti₅O₁₂), a conductive material (acetylene black) and a binder (PVdF) were mixed at anode active material:conductive material:binder=85:10:5 (weight ratio (wt %)), and applied onto an aluminum foil to produce an anode. Also, an evaluation battery was obtained in the same manner as Example 1 except for using a mixture, in which NaN(SO₂F)₂, LiN(SO₂F)₂ and KN(SO₂F)₂ were mixed at NaN(SO₂F)₂: LiN(SO₂F)₂:KN(SO₂F)₂=10:80:10 (molar ratio), for an electrolyte layer. Incidentally, when NaN(SO₂F)₂ having a melting point of 103° C., LiN(SO₂F)₂ having a melting point of 127° C. and KN(SO₂F)₂ having a melting point of 103° C. were mixed, the molten salt having a melting point of 62° C. was obtained.

### Comparative Example 1

A cathode active material, a conductive material (carbon material), and a binder (PVdF) were mixed at cathode active material:conductive material:binder=85:10:5 (weight ratio (wt %)) to produce a cathode, and an evaluation battery was obtained in the same manner as Example 1 except for using a solution such that LiPF₆ was dissolved at a ratio of 1.0 mol/dm³ in a solvent, in which ethylene carbonate (EC) and diethyl carbonate (DEC) were mixed at EC:DEC=3:7 (volume ratio (vol %)), for a liquid electrolyte.

### Comparative Example 2

An evaluation battery was obtained in the same manner as Comparative Example 1 except for mixing an anode active material (Li₄Ti₅O₁₂), a conductive material (acetylene black) and a binder (PVdF) at anode active material:conductive material:binder=85:10:5 (weight ratio (wt %)), which were applied onto an aluminum foil to produce an anode.

[Evaluations]

(Charge and Discharge Test)

A charge and discharge test was performed for the evaluation battery obtained in Examples 1 and 2 and Comparative Examples 1 and 2. Incidentally, the number of cycles and each condition during charge and discharge are as follows. The results of 1 C capacity per weight of the cathode active material in the third cycle and rate characteristics of 5 C/1 C are shown in Table 1. Incidentally, in Table 1, “Li₄Ti₅O₁₂” and “N(SO₂F)₂” are described while abbreviated as “LTO” and “FSA”, respectively.

During charge: CC 4.8 V 1 C (170 mAh/g=1 C)

During discharge: CC 3 V 1 C (170 mAh/g=1 C)

Temperature: 80° C. (Examples 1 and 2), 25° C. (Comparative Examples 1 and 2)

TABLE 1

| | | | | 1 C CAPACITY PER | |
|---|---|---|---|---|---|
| | | | | WEIGHT OF CATHODE | RATE |
| | | LIQUID ELECTROLYTE | | ACTIVE MATERIAL IN | CHARACTERISTICS |
| | ANODE | SALT | SOLVENT | THIRD CYCLE (mAh/g) | OF 5 C/1 C (%) |
| EXAMPLE 1 | HARD CARBON | NaFSA + LiFSA | NONE | 115 | 86 |
| EXAMPLE 2 | LTO | NaFSA + LiFSA + KFSA | | 112 | 92 |
| COMPARATIVE | HARD CARBON | LiPF₆ | EC + DEC | 62 | 48 |
| EXAMPLE 1 | | | | | |
| COMPARATIVE | LTO | | | 73 | 42 |
| EXAMPLE 2 | | | | | |

As shown in Table 1, high capacity and favorable rate characteristics were obtained from the results of the charge and discharge test in the evaluation battery of Examples 1 and 2 using the predetermined molten salt for an electrolyte layer, as compared with the evaluation battery of Comparative Examples 1 and 2 using conventional liquid electrolyte and solvent. The reason therefor is conceived to be that a large amount of an Li salt exists in the electrolyte layer in the evaluation battery of Examples 1 and 2. Incidentally, in the evaluation battery of Comparative Examples 1 and 2, it is conceived that an Li salt existing in the electrolyte layer was very small in amount as to bring low capacity, and the fluctuation of salt concentration became so violent that the change of conductance became large and favorable rate characteristics were not obtained.

### REFERENCE SIGNS LIST

1 cathode active material layer
2 anode active material layer
3 electrolyte layer
4 cathode current collector
5 anode current collector
6 battery case
10 hybrid ion battery
20 Heating unit
21 Temperature detection unit
22 Control unit
30 Hybrid ion battery system

1. A hybrid ion battery system comprising:
a hybrid ion battery formed of a Li ion and a Na ion;
the hybrid ion battery includes a cathode active material layer containing a cathode active material, an anode active material layer containing an anode active material, and an electrolyte layer formed between the cathode active material layer and the anode active material layer, the cathode active material is an active material containing at least Na, the anode active material is an active material capable of absorbing and releasing the Li ion, the electrolyte layer contains a molten salt composed of LiN(SO₂F)₂ and NaN(SO₂F)₂ and contains no solvent; and
a heating unit that heats the hybrid ion battery to a temperature such that the molten salt becomes in a molten state.

2. The hybrid ion battery system according to claim 1, wherein the anode active material is hard carbon or Li₄Ti₅O₁₂.

3. The hybrid ion battery system according to claim 1, wherein the cathode active material contains an Na₄M₃(PO₄)₂P₂O₇ crystal phase (M is at least one kind of Co, Ni, and Mn).
